(19) United States
(12) Patent Application Publication
(10) Pub. No.: US 2015/0361278 A1
(43) Pub. Date: Dec. 17, 2015

(54) TREATMENT OF FREQUENTLY TOUCHED SURFACES TO IMPROVE HYGIENE

(71) Applicant: Cleanspot, Inc., Albuquerque, NM (US)

(72) Inventors: Charles J. Call, Albuquerque, NM (US); Thomas S. Corbitt, Albuquerque, NM (US); David Karshmer, Santa Fe, NM (US)

(73) Assignee: CLEANSPOT, INC., Albuquerque, NM (US)

(21) Appl. No.: 14/832,210

(22) Filed: Aug. 21, 2015

Related U.S. Application Data
(63) Continuation of application No. PCT/US14/17513, filed on Feb. 20, 2014.
(60) Provisional application No. 61/767,252, filed on Feb. 21, 2013.

(51) Int. Cl. C09D 5/14; B05D 1/28; B05D 1/02; A01N 33/00; B05D 5/00

(52) U.S. Cl. CPC C09D 5/14; A01N 33/00; B05D 5/00; B05D 1/02; B05D 1/28

(57) ABSTRACT

A method for treating a surface touched by people to reduce an amount of microbes transferred to people touching the surface, the method comprising the step of depositing a conformal coating onto the surface, the coating comprising an ablative layer, the ablative layer being formed of a material sufficiently soft or frangible such that the ablation layer is worn away in response to repeated human contact, said coating comprising a material that is hydrophobic when the conformal coating has cured.

### RELATED APPLICATIONS

This application is a continuation of international application Serial No. PCT/US14/17513 filed on Feb. 20, 2014, which claims benefit of provisional application 61/767,252, filed Feb. 21, 2013, which are incorporated herein by reference as if fully set forth herein.

### TECHNICAL FIELD

The present invention has to do with the prevention of the spread of microbial infection. More specifically, the present invention has to do with a surface coating that acts to prevent the coated surface from serving as a transmission area for microbes.

### BACKGROUND ART

At the home, office, school or many other public places, many people come in contact with the same surface or object. An example of such a surface is the handle for the refrigerator in one's home or the coffee pot handle at the office. It would be desirable to provide improved devices and methods for reducing the transfer of microbes from one person to the next; whereupon each person comes in physical contact with the same surface. It would further be desirable to provide a coating that can be applied to surfaces of arbitrary shape and texture.

It would be desirable to provide a method and apparatus to efficiently enable such frequently contacted surfaces to be treated with a cleansing agent capable of reducing germs and that is capable of maintaining its antimicrobial effectiveness over an extended period of time.

### SUMMARY

The concepts disclosed herein encompass self-cleansing and antimicrobial surface modifications, and more specifically, thin films or stickers that can be applied to frequently touched surfaces and objects to reduce the rate at which microbes are transferred from one person to the next. The concepts disclosed herein further encompass self-cleansing and antimicrobial surface modifications that can be applied as a spray-on or wipe-on coating to frequently touched surfaces and objects to reduce the rate at which microbes are transferred from one person to the next and to reduce the rate at which said microbes can generate odors.

Compounds such as nano scale titanium dioxide (TiO2), when exposed to ultraviolet light, are capable of generating highly-reactive oxygen species. An example of highly reactive oxygen species is the oxygen radical. Highly-reactive oxygen generators, sometimes referred to herein as oxidizers, are known to be antimicrobial agents. However, other organic or bio-organic materials that are not microbes can also be decomposed by these highly reactive oxygen species. In the context of describing an antimicrobial agent in terms of the ablation layers discussed herein, such oxygenation agents/reactive oxygen generators are to be understood to be types of antimicrobial agents.

The ablation layer is configured to be ablated (or worn away) in response to handling (i.e., in response to human touch). As the outer surface of the ablation layer is worn away over time, fresh surface is uncovered, such that the self-cleansing property of the sticker remains effective longer than a comparable product having a harder touch surface. The ablation allows a dirty, microbe laden upper surface to be worn away, exposing a fresh, clean surface to the ambient environment. A hard-touch surface (i.e., a less ablative surface) that incorporates an antimicrobial agent would become ineffective over time, due to the antimicrobial being used up (leached out) or being covered up by dirt and grime (including killed microbes), and no ablation would occur to refresh the antimicrobial properties of the hard surface).

In a first separate aspect, the present invention may take the form of a method for treating a surface touched by people to reduce an amount of microbes transferred to people touching the surface, the method comprising the step of depositing a conformal coating onto the surface, the coating comprising an ablative layer, the ablative layer being formed of a material sufficiently soft or frangible such that the ablation layer is worn away in response to repeated human contact, said coating comprising a material that is hydrophobic when the conformal coating has cured.

In a second separate aspect, the present invention may take the form of a surface treatment comprising a container and a fluid, said fluid being readily dispensed from said container, and said fluid comprising a material that is hydrophobic when not in solution, and easily worn by repeated contact with human skin; a solvent; and an antimicrobial. Accordingly, the fluid forms a conformal coating onto a surface on which the fluid is deposited after the solvent has evaporated, and whereby the conformal coating so formed is sufficiently soft or frangible such that the conformal coating is worn away in response to repeated human contact.

In a third separate aspect, the present invention may take the form of a hand sanitizer comprising a container and a fluid, said fluid being readily dispensed from said container, and said fluid comprising a material that is hydrophobic when not in solution, and easily worn by repeated contact with human skin; a solvent; and an antimicrobial. Accordingly, the fluid forms a conformal coating onto human skin upon which the fluid is deposited after the solvent has evaporated, and whereby the conformal coating so formed is sufficiently soft or frangible such that the conformal coating is worn away in response to repeated human skin contact with other objects.

In a fourth separate aspect, the present invention may take the form of a touch screen sanitizer comprising a container and a fluid, said fluid being readily dispensed from said container, and said fluid comprising a material that is hydrophobic when not in solution, and easily worn by repeated contact with human skin; a solvent; and an antimicrobial. Accordingly, the fluid forms a conformal coating onto a touch screen upon which the fluid is deposited after the solvent has evaporated, and whereby the conformal coating so formed is sufficiently soft or frangible such that the conformal coating is worn away in response to repeated human skin contact with the touch screen.

A first example fabrication technique for generating the ablation layer comprises producing an emulsion or solution of a polymer and one or more antimicrobial agents. Depending on the polymer selected, the mixture can be self-cured, or forcibly cured (e.g., by heat or by a UV light for a light-curing polymer such as PDMS). The polymer employed, when cured, should exhibit wear properties such that that repeated contact with human skin will result in the desired ablation.

A second example fabrication technique for generating the ablation layer comprises dispersing microcapsules of one or more antimicrobial agent into a polymer that is either inherently weak, or which becomes weakened by direct exposure to ambient air or light, or a polymer that is modified so as to exhibit the desired ablation. As example, such modification can be achieved by adding a sufficient amount of very fine micro or nano scale powder as a diluent, reducing the integrity of the polymer, such that repeated contact with human skin will result in the desired ablation. The particles could also change the texture of the surface, leading to enhanced grip. The polymer of this second example could be a mixture of polymer and antimicrobial or oxidative agents as described in the first example.

A third example fabrication technique for generating the ablation layer comprises dispersing powder that has antimicrobial or oxidative properties into a polymer that is either inherently weak, or which becomes weakened by direct exposure to ambient air or light, or a polymer that is modified so as to exhibit the desired ablation. As described above, such modification can be achieved by adding a significant amount of very fine scale powder as a diluent, reducing the mechanical strength and increasing the wear rate of the layer. In some embodiments, all of the powder added to the polymer to form the ablation layer has antimicrobial properties, while in other embodiments, both antimicrobial and/or high-reactive oxygen generating powder plus a non-antimicrobial powder (an inert material) is added to the polymer to achieve the desired mechanical and antimicrobial properties. The resulting polymer based ablation layer should exhibit wear properties such that that repeated contact with human skin will result in the desired ablation.

A fourth example fabrication technique for generating the ablation layer comprises dispersing a material that has antimicrobial properties in a binder material such as poly ethylene glycol (PEG), to achieve a conformal coating without a discreet adhesive layer. The PEG-based coating is inherently weak relative to a cross-linked polymer, and may further include an additive to further modify its wear properties (a relatively small amount of cosmetic grade kaolin will give the ablative layer a bit of a gritty texture to enhance grip, while also making the ablative layer wear faster). When the coating is substantially worn in some areas of the frequently touched surface, it can be removed by soap or a solvent such as ethanol (grain alcohol) or rubbing alcohol. In this example, the coating is fabricated by spraying a coating mixture which has been diluted with a solvent such as isopropanol (rubbing alcohol) directly onto the surface and then letting it dry. The surface could be a hard surface, such as a door handle, or a porous surface, such as an article of clothing. Alternatively, the ablative coating materials could be incorporated into a wet wipe product such as a Clorox brand Disinfecting Wipe. Applying the coating with a wet wipe, followed by drying, will work best if the surface is a hard surface with low or non-existent porosity.

For both the second and third fabrication example techniques noted above, adding a powder to the polymer is one way to weaken the polymer so that it will wear down at a desired rate, to maintain a consistent level of self-cleansing and antimicrobial activity over an extended period of time. For the fourth example fabrication techniques noted above, the binding material is selected specifically for its mechanical and solvation properties. It is desired that the binder is soluble in an alcohol but not soluble in water, and preferably hydrophobic, when the coating is dry. With these properties the conformal coating it is not easily washed off with water or water-based cleaners, but yet can still be easily removed by an alcohol or hydrocarbon based cleaning agent. For example, an alcohol-impregnated wet wipe could be used to remove the coating when desired, for example, just prior to a re-application of the coating to a frequently touched surface.

It should be understood that if desired, any of the fabrication techniques discussed herein could be modified to eliminate the addition of the antimicrobial agent or oxidizing agent, such that the resulting ablative layer does not exhibit antimicrobial properties. Note that such stickers or conformal coatings including no active antimicrobial agent or oxidizing agent will still tend to reduce the spread of microbes from one person to the next due to touching common surfaces (touch points), because continual contact with the ablative layer will regularly expose a fresh surface, upon which little or no microbial colonies will have been able to develop or spread. Such clean only ablative coatings, that exhibit no inherent antimicrobial properties (i.e., which include no antimicrobial or oxidizing agent) will work best in high traffic areas, where constant handling results in a continually freshened surface, and microbial colonies have little time to develop or spread between successive ablations. In at least one such clean only ablative embodiment, the ablative coating is sufficiently thick to provide from about one to seven days of useful life (noting that such timeframes are exemplary, and not limiting). In such an embodiment, the cost is relatively low, so you clean perhaps as often as once per day, but you get the self-cleansing effect throughout that time period (and perhaps even if one forgets to clean daily). In at least one exemplary but not limiting embodiment, the relative thickness of the conformal ablative self-cleansing coating is about 50 microns.

The self-cleansing stickers disclosed herein can include ablation layers formed using combinations of the above techniques. For example, a liquid antimicrobial can be dispersed as an emulsion or mixture or microcapsules, and the binding polymer can incorporate a second antimicrobial or a highly-reactive oxygen species generator in powder form. As another example, a binding polymer can mixed with a miscible antimicrobial agent, and then a powder mixture is added prior to being applied as a top coating on a sticker. The power mixture in this example can be an inert powder, or a powder containing a generator of highly-reactive oxygen species.

In another exemplary embodiment, the ablation layer can be non-contiguous. Discrete antimicrobial structures can extend away from the underlying surface as the outer surface of the antimicrobial layer, protruding into the environment. Each such antimicrobial structure can be formed using one or more of the techniques noted above to form an ablation layer.

In an exemplary embodiment, the self-cleansing sticker includes a “remaining life” indicator that, at a minimum, alerts the user that the ablation surface is spent, and therefore, in need of replacement by a new sticker. Such an indicator can be implemented by a third layer, disposed between the adhesive layer and the ablation layer, which becomes exposed when the ablation layer is worn substantially or completely through. Alternatively, the indicator can be dispersed into the adhesive layer. Remaining life can be communicated to the user by sight (e.g., a color change), feel (e.g., roughness) or smell (e.g., release of an odor), as exemplary but non-limiting examples. In one exemplary embodiment, the adhesive layer (or an additional layer disposed between the adhesive layer and the active layer including the antimicrobial agent) can incorporate some sandpaper grit. When the ablation layer is worn down, the user will sense the sticker exhibiting a gritty texture not associated with a new sticker. The concepts disclosed herein also encompass adding a gritty tactile layer in between the adhesive layer and the ablation layer to function as an end of life indicator.

The remaining life indicator could also be based on an electronic sensor. In a first embodiment, the sensor can be placed on the surface that is frequently touched prior to an ablative coating being applied to the surface. After the coating is applied, the sensor can measure how much of the coating remains at that location. A measurement such as capacitance, magnetic field, conductivity, pH or water vapor might be used to indicate whether or not the ablative coating remains at that location, or has been rubbed off. In each case, an additive to the ablative layer may be dispersed, such as nano scale iron particles that would cause a change in the magnetic field as the ablative layer was worn down.

In a second embodiment, the sensor is a light sensor. The ablative coating could include a tag or dye that can be readily observed by the light sensor. As the coating is worn away, the signal from the sensor will be reduced and/or disappear. The wavelength of the tag or dye can be matched to the sensor's optimal response, and the sensor performance can be improved by covering the sensor window with a band pass filter centered on the tag emission wavelength. The sensor could be a camera, and in this case, the signal becomes an image of the frequently-touched surface. The camera could observe a tag dispersed in the ablative coating that absorbs, fluoresces or thermally emits in infrared range. For example, FLIR Systems, Inc. (Portland, Oreg.) has announced the release of a low-cost, long-wavelength infrared camera. This imager could be used to report the disappearance of a dye designed to emit brightly in a specific wavelength that can be readily observed by this camera, but yet is invisible to the human eye.

An electronic remaining life indicator has the added benefit that it can communicate wirelessly with other devices and surfaces, providing a smart environment capable of reporting the overall hygiene status of a room or zone in a building, and report specific touch points that are in need of a new sticker or coating. An example of a wireless communication technology for communicating sensor data is an RFID tag. All of these types of electronic sensors can be incorporated into the stickers disclosed herein. In a particularly preferred embodiment, the sensor can wirelessly communicate with a mobile computing device, such as a tablet or smart phone (or to a network gateway such as a “smart” smoke alarm, heater control, or other smart device that is itself connected to a local wireless network), to alert a user that the ablative conformal coating or sticker including the ablative layer needs to be replaced. In some embodiments the wireless communication is relatively short range (such as Bluetooth or Wi-Fi), and the mobile computing device or other network gateway needs to be relatively close to the sensor, while in other embodiments the wireless communication is relatively longer range, such as GPRS or CDMA cellular communication, and/or long range radio. An example of a “smart” smoke alarm is the Nest Protect smoke detector.

In an exemplary embodiment, the ablation layer can be structured (e.g., dimpled, or grooved), such that the when the structures are worn off due to ablation, the sticker becomes smooth to the touch, and users will recognize that the sticker is spent and should be replaced with a fresh sticker.

The inventions disclosed herein also encompass self-cleansing stickers comprising at least three layers. Such self-cleansing stickers comprise a bottom adhesive layer, a middle supporting or “carrier” layer, and an upper ablative layer. The ablative layer can include a plurality of non-contiguous antimicrobial structures, which are supported by the carrier layer (which functions as a substrate). The carrier layer provides structural support. The ablation layer by design is not durable. The adhesive layer simply provides adhesion. The carrier layer, in embodiments including such a layer, provides structural support that enables spent stickers to be readily removed from a surface. The lower adhesive layer enables the self-cleansing sticker to be attached to a frequently handled surface to provide antimicrobial treatment to that surface. The adhesive layer is disposed on the bottom of the sticker, so that when the sticker is in use the adhesive layer is in a facing relationship with the surface to receive antimicrobial treatment. A lower liner layer, configured to be removed before the sticker is attached to the surface needing antimicrobial treatment, can cover the lower surface of the adhesive layer before the sticker is used. The upper antimicrobial layer is disposed on the top of the sticker, so that when the sticker is in use the plurality of non-contiguous antimicrobial structures are exposed to the ambient environments (i.e., the upper antimicrobial layer is generally parallel to the surface to receive antimicrobial treatment). An upper liner layer, designed to be removed before the sticker is used, can cover the upper antimicrobial layer before the sticker is used. If desired, remaining life or wear indicators can be disposed underneath some or all of the non-contiguous antimicrobial structures, so that as the non-contiguous antimicrobial structures are worn away, the remaining life indicators are exposed. In an exemplary embodiment, the non-contiguous antimicrobial structures are printed onto the middle substrate layer. In some embodiments, the non-contiguous antimicrobial structures are disposed in a random pattern. In other embodiments, the non-contiguous antimicrobial structures are disposed in an ordered or predefined pattern. In an exemplary embodiment, the non-contiguous antimicrobial structures comprise dot like structures dispersed on an upper surface of the middle substrate layer.

In some embodiments, the self-cleansing sticker is sufficiently flexible so as to conform to curved surfaces. In an exemplary embodiment the sticker is fabricated into a roll (analogous to paper towels or adhesive tape), and used like tape to wrap an object such as a door handle.

In some embodiments, the adhesive layer of the self-cleansing sticker has a gripping power that enables the self-cleansing sticker to be easily attached to the surface to be treated and remain firmly attached to the surface during the useful life of the sticker. The adhesive layer can comprise a non-permanent adhesive; it can be desirable that the sticker (and the adhesive) be easily removed when the sticker is spent and requires replacement.

In an exemplary embodiment the adhesion layer not only exhibits adhesive properties, but structural properties as well. In such an embodiment the adhesive layer provides sufficient mechanical strength so that a worn out sticker has enough remaining structural integrity to be peeled away from the surface on which it was deposited in one piece, so users will not need to spend time trying to remove bits and pieces of a spent sticker from the surface. Such structural properties can also be included in any of the sticker embodiments disclosed herein, by adding a separate structural layer.

In some embodiments, the adhesive layer is replaced by a treatment on the lower side of the carrier layer. The treatment could be oxidative plasma etch or ion impaction such that they surface will adhere to clean flat surfaces such as glass. In these embodiments, the carrier layer is functioning as both carrier and adhesive and may be described as a carrier layer or an adhesive layer.

In an exemplary embodiment, the self-cleansing sticker is substantially transparent and is affixed to a smart phone, tablet or other touch screen device. The sticker acts as a self-cleansing screen protector, protecting the screen for scratches while also producing a clean, hygienic surface.

In yet another exemplary embodiment, the self-cleansing sticker includes an ablative layer that employ a cosmetic grade clay powder that allows the ablative coating to wear down after repeated touching, renewing its surface. Such an ablative coating can also include a light-active oxidizer, an anti-microbial agent, and a binding agent.

Other objects, advantages and novel features, and further scope of applicability of the present invention will be clear to one skilled in the art of membranes and antimicrobial materials.

This Summary has been provided to introduce a few concepts in a simplified form that are further described in detail below in the Description. However, this Summary is not intended to identify key or essential features of the claimed subject matter, nor is it intended to be used as limiting the scope of the claimed subject matter.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 schematically illustrates a first exemplary embodiment of a self-cleansing sticker including an adhesive layer and an ablation layer, with an antimicrobial agent/antimicrobial material included in the ablation layer;

FIG. 2 schematically illustrates the self-cleansing sticker of FIG. 1 including optional removable covers or liners, placed over the ablation layer and the adhesive layer during storage, the liners to be removed before using the sticker;

FIG. 3 schematically illustrates a second exemplary embodiment of a self-cleansing sticker including an adhesive layer, a supporting/structural layer, and an ablation layer;

FIG. 4 graphically illustrates an empirical efficacy test on a self-cleansing sticker generally consistent with FIGS. 1 and 3, wherein Test #1 corresponds to the sticker in its “new” condition, and wherein Test #2 was completed after the same sticker was ablated with 1000 grit sand paper for five minutes;

FIG. 5 schematically illustrates a second exemplary embodiment of an self-cleansing sticker including an adhesive layer, a supporting layer and an ablation layer, with an antimicrobial agent/material dispersed throughout the ablation layer, and the ablation layer including a plurality of surface features or patterns; to enhance a gripping characteristic of the fresh sticker;

FIG. 6 schematically illustrates a self-cleansing ablative film being deposited onto a surface, by spraying and/or wiping a liquid material on a surface, and then allowing the liquid to dry, forming a conformal ablative coating on the surface; and

FIG. 7 is a flowchart illustrating method steps generally consistent with FIG. 6;

FIG. 8 is a functional block diagram of both a kit and a system generally consistent with FIG. 6;

FIG. 9 is a flowchart illustrating a method related to the method of FIG. 7, in which a fog is introduced into an enclosed volume to treat surfaces therein with a self-cleansing ablative conformal coating.

FIG. 10 is a schematically illustrates a wear rate testing apparatus that can be used to evaluate the ablative layers disclosed herein for desirable wear properties; and

FIG. 11 graphically illustrates empirical test results obtained using the apparatus of FIG. 10.

### DETAILED DESCRIPTION OF THE PREFERRED EMBODIMENTS

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed from the examples shown in the drawings and discussed herein. Further, one or more features of one embodiment disclosed herein can be combined with one or more features of any other embodiment that is disclosed, unless otherwise indicated. It should be recognized that relative sizes and shapes of elements in the Figures, such as but not limited to layers, are intended to be exemplary, and not limiting.

In a first exemplary embodiment, a self-cleansing sticker is formed by first coating a liner material (e.g., by spraying) with an adhesive similar to the adhesive used on ordinary bandage or tape. The adhesive can be selected from a class that allows the sticker to be affixed to an object by applying pressure across the surface of the sticker and subsequently peeled off (e.g., removed) from the object without leaving behind undesirable amounts of the adhesive, or adhesive that is not amenable to simple cleaning steps.

Disposed on top of the adhesive layer is an antimicrobial layer comprised of an antimicrobial agent (and/or a generator of highly-reactive oxygen species) dispersed into a polymer layer. The flexible polymer layer is comprised of a material that can be worn down (ablated) by repeated touching by humans. As this ablation surface is worn, fresh antimicrobial is continuously exposed on the surface, thereby maintaining a constant antimicrobial activity of the surface over an extended period of time. Eventually this ablation layer will be worn down toward the adhesive layer, and the sticker can be peeled off and discarded. A new sticker can be affixed in place of the removed sticker. Alternatively, a new sticker can be placed on top of the worn sticker.

In sticker embodiments that include no antimicrobial agent (only an ablation layer), continually exposing a fresh clean surface prevents buildup of large numbers of microbes, reducing the likelihood of the spread of microbial contamination across frequently contracted surfaces.

The ablation layer can be constructed by any of several methods, or combinations thereof, as described in the examples below.

By dissolving one or more antimicrobial compounds into the polymer (e.g., mixing Polyhexanide (polyhexamethylene biguanide, aka PHMB, supplied by Arch Chemical)) into a flexible but non-durable polymer (e.g., polycaprolactone). This can be accomplished by mixing the desired concentration of antimicrobial compound into solvated polycaprolactone, and subsequently, allowing the mixture to harden (by evaporating off the solvent).

By dispersing one or more antimicrobial (such as PHMB or nano-silver particles) into a flexible, but durable polymer (such as polydimethylsiloxane (PDMS)) and further mixing in a concentration of a non-soluble solid material (such as an organic powder or a mineral powder) sufficient to mechanically weaken the polymer layer such that it exhibits a desirable ablation rate. In an exemplary embodiment, the ablation layer can be worn away after a period of 10-12 weeks, based on multiple contacts by users on a daily basis. Note that in embodiments where no antimicrobial or oxidative agent is included in the ablative layer, it will be beneficial to utilize “softer” ablative layers that wear more rapidly. Such ablative only layers will be relatively less expensive because no antimicrobial or oxidative agent is included, but will wear faster and need to be replaced more often given the same quantity of ablative material. In some embodiments the non-soluble solid material added to weaken the polymer exhibits antimicrobial properties, while in other embodiments the non-soluble solid material has no antimicrobial properties. The inventions disclosed herein also encompass embodiments where the ablation layer includes both a non-soluble solid material that exhibits antimicrobial properties, as well as a non-soluble solid material has no antimicrobial properties. The relative proportion of the non-soluble solid material can be adjusted to achieve a desired ablation rate. Adding relatively more of the non-soluble solid material to the polymer generally leads to increased ablation rates, while adding relatively less of the non-soluble solid material to the polymer generally leads to decreased ablation rates (assuming the same degree of user contact with the ablation layers). For self-cleansing stickers in high traffic areas, it may be preferable to provide relatively lower ablations rates, whereas for self-cleansing stickers in low traffic areas, it may be preferable to provide relatively higher ablations rates.

Many different types of antimicrobial agents can be dispersed into the polymer material to generate an ablation layer. In general, any material or combination of materials exhibiting antimicrobial properties can be employed. Where combinations of materials are employed, it is preferable that the various materials when used together do not inhibit the antimicrobial properties of the ablation layer. Exemplary antimicrobial materials include, but are not limited to, silver, silver compounds, copper, copper compounds, zinc compounds, titanium compounds, ammonium alum, oxidizers, PHMB, compounds containing quaternary ammonium functional groups, PPE DABCO, OPE-DABCO, commercially available antimicrobial formulations (such as those marketed by Dow Chemical; BIT and MBIT), and compounds that are activated by the absorption of visible or ultraviolet light. Upon absorption of photons, some compounds generate highly reactive oxygen species, which are thought to be generated as a result of the formation of “singlet oxygen.” Highly-reactive oxygen species are known to be effective antimicrobial compounds and can function to clean the surface, rendering the surface self-cleansing. US Patent Publication 20100190004 (Gibbins) discloses antimicrobial agents that can be used in the self-cleansing stickers disclosed here.

The antimicrobial or oxidative agent can be used in liquid form, gel form, solid form, encapsulated in microspheres, or combinations thereof, where said antimicrobial encapsulation allows the antimicrobial compound to be released only as the ablation layer is worn, exposing the microcapsules to ambient air and human contact, at which point the encapsulation material is compromised and the antimicrobial becomes available for killing microbes on the surface of the ablation layer The inventions disclosed herein encompass combinations and permutations of the above.

The ablation layer is configured so that the sticker will last for a defined period of time and provide a consistent level of activity over that time period. The wear properties of the ablation layer can be varied to provide a relatively longer wearing surface or a relatively shorter wearing surface. Without ablation, to maintain a hygienic surface with relatively low counts of viable microbes, the sticker (or conformal coating) must rely on diffusion of antimicrobial material from within the layer exposed to the ambient environment in order to maintain activity or must rely upon a tightly bound antimicrobial material on the surface. However, the level of activity would necessarily decrease with time as the antimicrobial material is rubbed off the surface or covered up by dirt and grime by repeated touching. One desirable way to maintain a consistently active surface (i.e., the surface exposed to the ambient environment) is to “refresh” or “regenerate” the surface by exposing a new layer. Thus, the ablation layer is rubbed off over time; each time the sticker is touched, ablation occurs, which refreshes the surface exposed to the ambient environment. Other antimicrobial stickers have been developed, such as that by Gibbins, or those currently being marketed by Nanotouch Materials, Inc., of Forest, Va., but heretofore, none have incorporated an ability to refresh the exterior surface of the active layer (i.e., the surface exposed to the ambient environment) with the aid of ablative properties, and thus, are not well suited for use over extended periods of time and over hundreds or even thousands of touches.

In an exemplary embodiment, the adhesive incorporated into the adhesive layer comprises a pressure sensitive adhesive. Other adhesives, such as a light or heat activated adhesives, or permanent adhesives, can make the sticker more difficult to affix (light or heat activated adhesive), or more difficult to remove when it is worn out (permanent adhesive), although they can be desirable for some applications.

In at least one series of exemplary embodiments, a color indicated dye is added to the adhesive, or added as an additional layer or coating between the adhesive layer and the ablation layer. This additional layer provides an indicator layer. In some embodiments, the dye will change from a relatively neutral or innocuous color to a very visible color (i.e., clear to black, red or another easily observed color) after a specified period of time. In some embodiments, the dye will change from a relatively neutral or innocuous color to a very visible color (i.e., clear to black, red or another easily observed color) when exposed to ambient air or human skin, such that it changes color when the ablation surface is worn down to this indicator layer, thereby indicating to the user that the sticker has worn out and had reduced effectiveness. In some embodiments, the indicator layer is a different color than the ablation layer, such that the indicator layer is only visible when the ablation layer is substantially worn through. In addition to the use of color as an indicator layer, the indicator layer can include text (for example, text that prompts replacement of the self-cleansing sticker, or words to that effect).

In an exemplary embodiment, a carrier layer is incorporated between the adhesive layer (or the indicator layer, if present) and the ablative layer. This structural layer can comprise a polymer that is not easily ablated by human touch, and thus, will remain intact when the sticker is worn out. This layer will be of a thickness and hardness that allows the user to easily peel away the worn out sticker. When sticker wears down, the structural layer can ensure that there is enough material strength remaining so as to be able to easily peel off the sticker without tearing it.

In some embodiments, the self-cleansing sticker is highly conformable, such that the sticker can be attached to a curved or arcuate surface (such as a door knob or door handle). In some embodiments, the self-cleansing sticker can be stretched to conform to a three dimensional shape. In some embodiments, the self-cleansing sticker is provided in square, rectangular, and/or circular form factors (such form factors being exemplary and not limiting) and users are instructed to cut the sticker into the desired shape. In some embodiments, the self-cleansing stickers are pre-cut for specific surfaces, such as specific makes and models of door handles, or other frequently touched surfaces.

### EXAMPLE 1

Without the sticker, the refrigerator door acts as a microbial reservoir, allowing microbes from one member of the family or guests to be easily transferred to another. Similarly, at the office, the refrigerator door is touched in the morning as office workers who bring a homemade lunch arrive at office, and then again around lunch time as these workers remove their lunch from the refrigerator. The refrigerator handle is a commonly touched surface and becomes a microbial reservoir which is capable of accumulating microbes from members of the household (or each office worker) using the refrigerator, and then transferring them to all the subsequent members of the household (or office workers) that use the refrigerator. A self-cleansing sticker according to the present invention can be affixed to a refrigerator door handle. A large fraction of the microbes that adhere to the sticker are killed by the sticker, and thus, the sticker makes the handle a microbial sink instead of a reservoir.

### EXAMPLE 2

The screen protector frequently applied to the touchscreens of a smartphone or tablet computer protects the glass surface from scratches. However, the self-cleansing sticker would not only protect the surface from scratches, but also present a cleaner, more hygienic surface to the user.

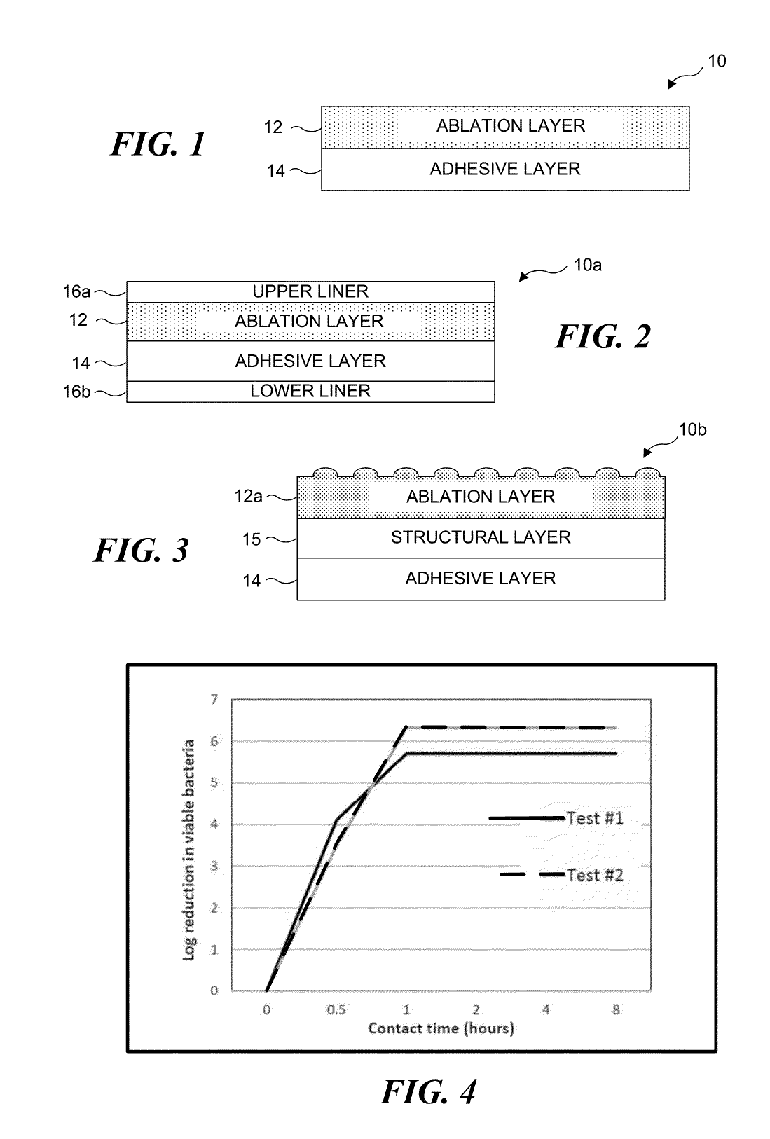

FIG. 1 schematically illustrates a first exemplary embodiment of a self-cleansing sticker 10 including an adhesive layer 14 and an ablation layer 12, with an antimicrobial material and/or a reactive oxygen generating material included in the ablation layer. The incorporation of antimicrobial or oxidative agents can be optional since the ablative property of the layer may be sufficient in some applications to maintain a clean, hygienic surface on the sticker. In some embodiments the antimicrobial material and/or a reactive oxygen generating material is dispersed substantially evenly throughout the ablation layer. In other, less preferred embodiments the antimicrobial material and/or a reactive oxygen generating material is not dispersed evenly throughout the ablation layer. In at least one embodiment, the antimicrobial material/reactive oxygen generating material is incorporated into the ablation layer as non-contiguous discreet particles. In yet another embodiment, the antimicrobial material/reactive oxygen generating material is incorporated into the ablation layer as non-contiguous discreet structures deposited on a layer surface of the ablation layer.

FIG. 2 schematically illustrates a self-cleansing sticker 10a including a lower liner 16b that is placed on the bottom of adhesive layer 14 during storage, and is removed before applying the sticker to the surface to be treated. Sticker 10a also includes an upper liner 16a that is placed over the ablation layer during storage. The upper liner can removed after applying the sticker to a surface to be treated, immediately after application or after the surface is to be placed into use (e.g., the sticker can be applied during manufacture of an object, and the upper liner removed by the consumer when the object is placed into service).

FIG. 3 schematically illustrates a self-cleansing sticker 10b including an adhesive layer 14 and an ablation layer 12a, with an antimicrobial agent/antimicrobial material included in the ablation layer. Note that ablation layer 12a includes a plurality of surface features or patterns, to enhance a gripping characteristic of the fresh sticker. Self-cleansing sticker 10b further includes a supporting layer 15 disposed between the adhesive layer and the ablation layer. The supporting (or carrier layer) provides structural support for the sticker. Such support enables the sticker to be readily removed from the surface once the ablation layer is spent. Absent such a supporting layer, the sticker could be hard to peel off of a surface in a contiguous piece. It should be understood that the surface features of ablation layer 12a are not required, and that the concepts disclosed herein encompass embodiments where no such surface features as included.

FIG. 4 shows the results from empirical testing using a sticker consistent with the embodiments of FIGS. 1 and 3, where the antimicrobial agent was generally uniformly dispersed throughout the ablation layer. The ablative layer was formed of 78% polydimethylsiloxane (PDMS), 20% alumina silicate powder, and 2% polyhexamethylene biguanide (PHMB). A liquid culture of Escherichia coli K12 was grown in 10 ml Lysogeny Broth (i.e., LB medium) overnight in a New Brunswick thermostat shaker at 36.7° C. Next, 50 μl of this culture was transferred to 10 ml fresh LB medium, and the culture was grown until the cell density reached 0.5 A600 absorbance unit. The actual cell numbers are counted in a 10-fold dilution series, of which 1 ml bacterial suspension is applied onto Petrifilm™ sheets (3M Corporation). The Petrifilm plates were then incubated at 36.7° C. overnight and the number of colony forming units (CFUs; appearing as red dots) were counted. Ten microliters of this solution was applied to a series of 1 cm×1 cm ablative stickers as described in ASTM test method E2180-07 (2012), with minor modifications. At various time intervals, the liquid in contact with the ablative coating was washed from the sticker and cultured to determine the viable bacteria remaining on the sticker. Each test was carried out with five replicates and the test results were averaged. The number of viable E. Coli on each surface was reduced rapidly by the antimicrobial properties of the ablative coating. The stickers were then allowed to dry and were ablated using 1000 grit sand paper, and then the test was conducted again. After ablating the surface, no degradation the antimicrobial properties of the surface was observed; in both cases 100% of the E. Coli where killed in one hour of contact time with the surface. The plateau in the graph is present because once 100% of the E. Coli have been killed, no further inactivation is possible over longer contact times, and the curve plateaus at the maximum value. This maximum value corresponds to the initial concentration of the E. Coli bacteria at time=0.

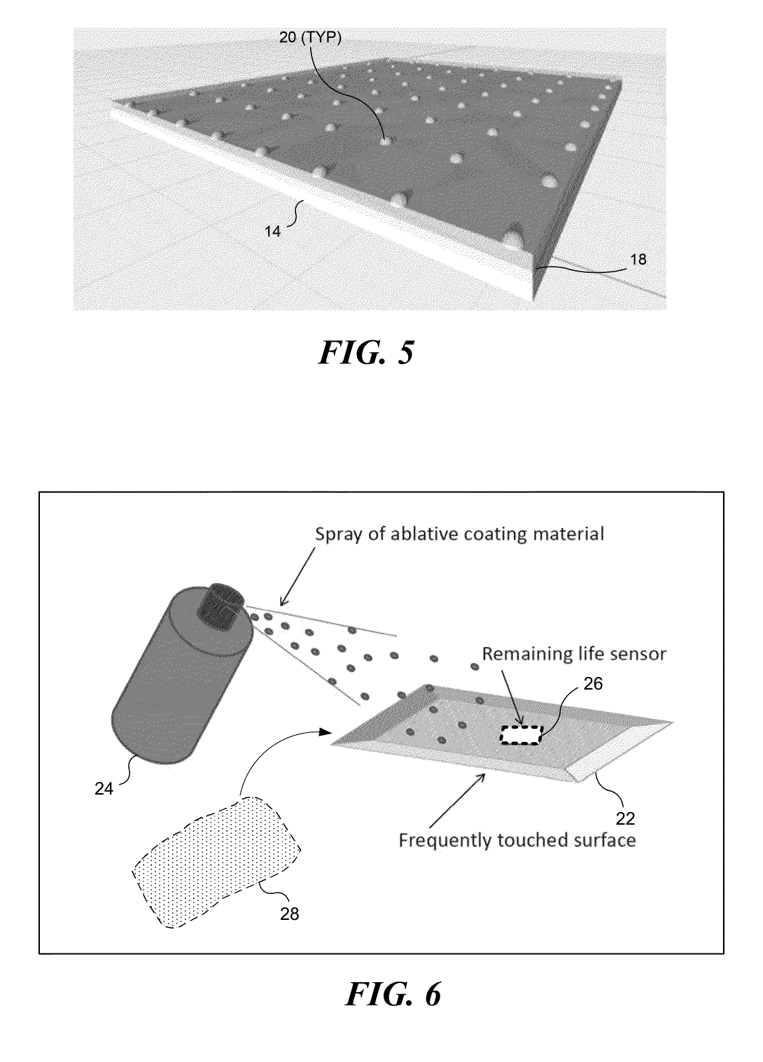

FIG. 5 schematically illustrates a first exemplary embodiment of another aspect of the inventions disclosed herein, a self-cleansing sticker including adhesive layer 14, a substrate layer 18, and a non-contiguous antimicrobial layer defined by a plurality of discrete antimicrobial structures 20. In this type of sticker, the sticker includes a bottom adhesive layer, a middle supporting layer (substrate layer 18), and an upper antimicrobial layer. The lower adhesive layer enables the self-cleansing sticker to be attached to a frequently handled surface to provide antimicrobial treatment to that surface. The adhesive layer is disposed on the bottom of the sticker, so that when the sticker is in use the adhesive layer is in a facing relationship with the surface to receive antimicrobial treatment. A lower liner layer, designed to be removed before the sticker is attached to the surface needing antimicrobial treatment, may cover the lower surface of the adhesive layer before the sticker is used. The upper antimicrobial layer is disposed on the top of the substrate layer (which supports the plurality of discrete antimicrobial structures). When the sticker is in use, the plurality of non-contiguous antimicrobial structures are exposed to the ambient environments (i.e., the upper antimicrobial layer is generally parallel to the surface to receive antimicrobial treatment). An upper liner layer, designed to be removed before the sticker is used, can cover the upper antimicrobial layer before the sticker is used. If desired, remaining life indicators can be disposed underneath some or all of the non-contiguous antimicrobial structures, so that as the non-contiguous antimicrobial structures are worn away, the remaining life indicators are exposed. In this embodiment, the non-contiguous antimicrobial layer can function as a remaining life indicator: when the sticker is worn smooth over a region encompassing approximately one square centimeter, then the sticker can be deemed to have no remaining life. The user can feel if there is one or more smooth areas at least the size of 1 square centimeter present on the sticker, and if so, replace the spent sticker with a fresh sticker.

The plurality of non-contiguous antimicrobial structures 20 can be deposited onto substrate layer 18 in a defined pattern or a random pattern. In some embodiments, the pluralities of non-contiguous antimicrobial structures are deposited onto the substrate layer in a grid pattern. In some embodiments each of the non-contiguous antimicrobial structures are substantially the same size and shape. In some embodiments the non-contiguous antimicrobial structures vary in at least one of size and shape. In an exemplary but not limiting embodiment, the non-contiguous antimicrobial structures are one the order of 1-3 mm in height. In some embodiments, each non-contiguous antimicrobial structure is ablatable (i.e., each non-contiguous antimicrobial structure can be worn down by repeated touch), generally as discussed above in regards to the ablation layer.

The terms about and approximately, as used above and in the claims that follow, should be understood to encompass a specified parameter, plus or minus 20%. The term significant amount, as used above and in the claims that follow, should be understood to encompass at least 25% by mass.

FIG. 6 schematically illustrates a self-cleansing ablative film being deposited onto a surface, by spraying and/or wiping a liquid material on a surface. A solution (alcohol based, water based, or alcohol and water based) that will form an ablative conformal coating upon evaporation of the solvent is provided in a spray applicator 24 or an optional wet wipe 28. Spray applicator can be based on a compressed aerosol spray can, or a finger actuated spray pump. If desired, an optional sensor (generally as discussed above in the Summary of the Invention) can be placed onto a selected portion of a touch point 22 (i.e., the frequently contracted surface, including but not limited to smart phone screen, a kiosk keypad, an ATM keypad, a public touchscreen display, a kitchen surface, a door handle/door knob, a restroom fixture, a restroom door, a shopping cart handle, and a soft drink beverage dispenser touchpad) before the liquid coating is applied. In at least one embodiment, the ablative conformal coating left on the touch point when the solvent evaporates is relatively thin (on the order of 50 microns), and is intended to be refreshed on a frequent basis (daily, or semi-weekly, perhaps as part of a janitorial cycle).

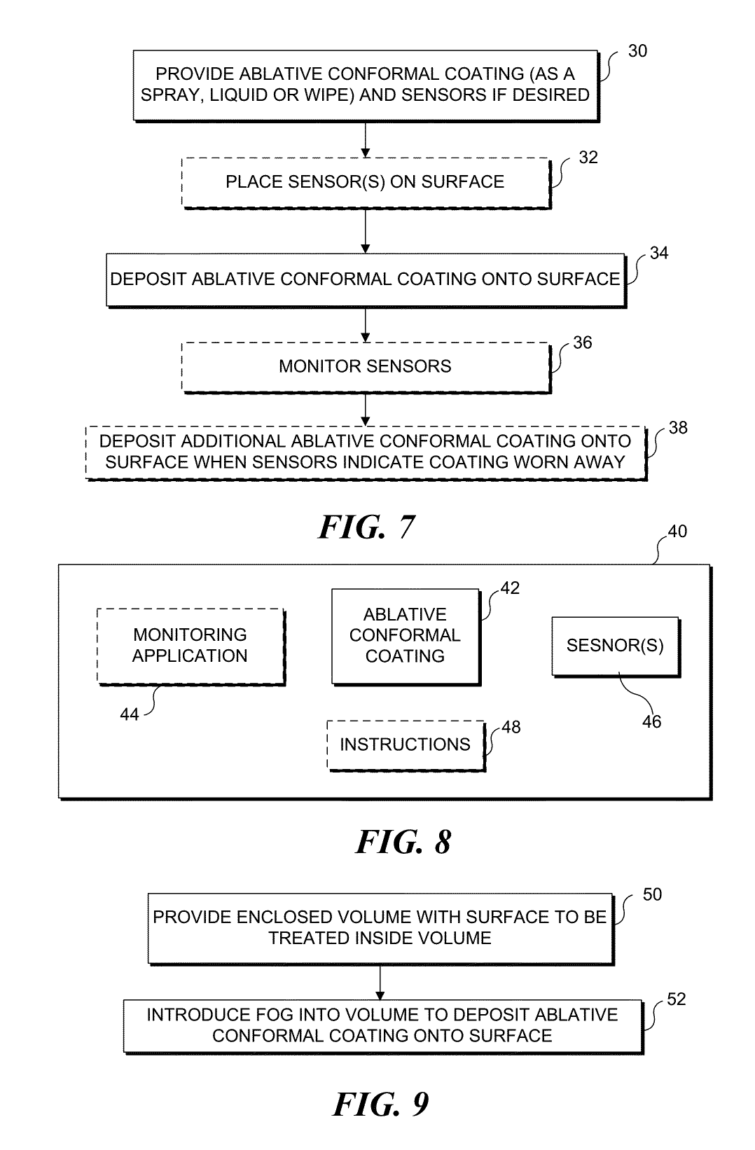

FIG. 7 is a flowchart illustrating method steps generally consistent with FIG. 6. In a block 30, a solution (alcohol based, water based, or alcohol and water based) that will form an ablative conformal coating upon evaporation of the solvent is provided. In one exemplary embodiment, the solution is provided in a disposable aerosol spray can. In another exemplary embodiment, the solution is provided in a disposable finger actuated pump spray dispenser (such dispensers are typically used for consumer based cleaning products, such as window cleaner). In yet another exemplary embodiment, the solution is provided as a bulk liquid (in one, five or, fifty gallon containers, such sizes being exemplary, rather than limiting), and end users employ an applicator of their choice (such as a spray dispenser or wipe applicator). In an optional block 32, one or more sensors are placed onto the touch point surface (i.e., the surface to be treated). Exemplary sensors include unpowered sensors (such as RFID tags) that are energized by collecting RF energy directed at the sensor, such energy being used to process and return data to an RFID reader, as well as sensors that include their own power source (albeit small, the sensors preferably having a compact form factor). Piezoelectric sensors, that can scavenge energy from being handled, can also be employed. In a block 34, the solution (alcohol based, water based, or alcohol and water based) is applied to the touch point, and the ablative conformal coating is formed upon evaporation of the solvent. In an optional block 36, the sensor is monitored to determine an indication that the ablative coating has worn through. As noted above, many different properties can be measured to provide an indication that the ablative layer is worn, including but not limited to a change in capacitance, magnetic field, conductivity, pH, light transmission, or humidity. Self-powered sensors can broadcast a signal indicative of a spent ablative coating, whereas non powered sensors will need to be queried (such as an RFID reader querying an RFID tag based sensor), perhaps as part of a daily or weekly inspection. 0 In an optional block 38, once a sensor signal indicates the ablative coating has worn through (or is thinning), an additional quantity of the ablative conformal coating can be deposited on the touch point.

FIG. 8 is a functional block diagram of both a kit and a system generally consistent with FIG. 6. In a first exemplary embodiment, a system 40 (and/or kit 40) includes an ablative conformal coating 42 (provided as a solution (alcohol based, water based, or alcohol and water based) that will form an ablative conformal coating upon evaporation of the solvent), one or more sensors 46 (generally consistent with the sensor types disclosed above), an optional monitoring application 44, and optional instructions 48. In at least one exemplary embodiment, monitoring application 44 is loaded onto a mobile computing device, such as a smart phone or tablet, and the application alerts the user when the ablative conformal coating needs to be replaced. In at least one exemplary embodiment, instructions 48 inform users on how to apply the ablative conformal coating, and how often to refresh the ablative conformal coating for optimal results.

In at least one embodiment, a desired ablation rate results in substantial wear of the ablation layer after being touched by human hands less than twenty five times. In at least one embodiment, a desired ablation rate results in substantial wear of the ablation layer after being touched by human hands more than twenty five times. In at least one embodiment, a desired ablation rate results in substantial wear of the ablation layer after being touched by human hands more than fifty times. In at least one embodiment, a desired ablation rate results in substantial wear of the ablation layer after being touched by human hands more than one hundred times. In at least one embodiment, a desired ablation rate results in substantial wear of the ablation layer after being touched by human hands more than two hundred and fifty times. In at least one embodiment, a desired ablation rate results in substantial wear of the ablation layer after being touched by human hands more than five hundred times. In at least one embodiment, a desired ablation rate results in substantial wear of the ablation layer after being touched by human hands more than seven hundred and fifty times. In at least one embodiment, a desired ablation rate results in substantial wear of the ablation layer after being touched by human hands more than one thousand times.

The concepts disclosed herein further encompass the following additional embodiments.

A self-cleansing conformal coating including an ablative layer. The ablative layer is formed of a material sufficiently soft or frangible such that the ablation layer is worn away in response to repeated handling or touching. In at least one embodiment the self-cleansing conformal coating is a sticker further including an adhesive layer. In at least one embodiment the self-cleansing conformal coating is sprayed onto a surface. In at least one embodiment the self-cleansing conformal coating is applied to a surface with a wipe.

A self-cleansing conformal coating solution to be applied to a surface using a spray or a wipe. The conformal coating solution includes poly ethylene glycol, ethanol and an antimicrobial agent. After application of the mixture, the ethanol evaporates leaving behind an ablative conformal coating.

A self-cleansing conformal coating solution to be applied to a surface using a spray or a wipe. The conformal coating solution includes poly ethylene glycol, ethanol, a cosmetic grade powder (such powder increasing a rate at which the resulting ablative coating will wear, compared to a similar ablative coating without such powder, kaolin clay being an exemplary but not limiting powder), and an antimicrobial agent. After application of the mixture, the ethanol evaporates leaving behind an ablative conformal coating.

A self-cleansing conformal coating solution to be applied to a surface using a spray or a wipe. The conformal coating solution includes poly ethylene glycol, ethanol, water and an antimicrobial agent. After application of the mixture, the ethanol and water evaporate, leaving behind an ablative conformal coating. In at least one related embodiment the antimicrobial agent includes PHMB and titanium dioxide. In another related embodiment, the spray is in the form of a dense fog to coat all the surfaces coming in contact with the fog.

The concepts disclosed herein further encompass a method of providing a sealable volume, and introducing a fog or vapor including a self-cleansing conformal coating solution (with or without an antimicrobial or oxidant element) into the volume, such that a self-cleansing ablative conformal coating generally as discussed above is deposited onto objects and surfaces within the volume. In at least one embodiment, the volume comprises a relatively small volume for human portable objects, while in at least one other embodiment the volume comprises a relatively larger volume that can accommodate one or more people (including but not limited to the interior of a passenger car, the interior of a bus, the interior of an aircraft, the interior of a room in a cruise ship, the interior of a meeting room, the interior of a movie theater, the interior of a concert hall, and/or the interior of a restroom).

Thus, another aspect of the present invention is a method for treating a surface to reduce an amount of microbes transferred to people from the surface, the method comprising the step of creating a fog of a solvated self-cleansing coating material inside of a contained space and allowing sufficient time for the fog to deposit onto the surfaces and dry, the coating comprising an ablative layer, the ablative layer being comprised of an antimicrobial material and a material sufficiently soft or frangible such that the ablation layer is worn away in response to repeated human contact.

FIG. 9 is a flowchart illustrating a method related to the method of FIG. 7, in which such a fog is introduced into an enclosed volume to treat surfaces therein with a self-cleansing ablative conformal coating. In a block 50, an enclosed volume is provided, in which one or more surfaces to be treated are included. As noted above, the enclosed volume can be relatively small, such that man portable items are included in the enclosed volume, or the enclosed volume can be relatively large enough to accommodate one or more person sized objects. In a block 52, a fog or vapor including a self-cleansing conformal coating solution (with or without an antimicrobial or oxidant element) is introduced into the volume, such that a self-cleansing ablative conformal coating generally as discussed above is deposited onto objects and surfaces within the volume.

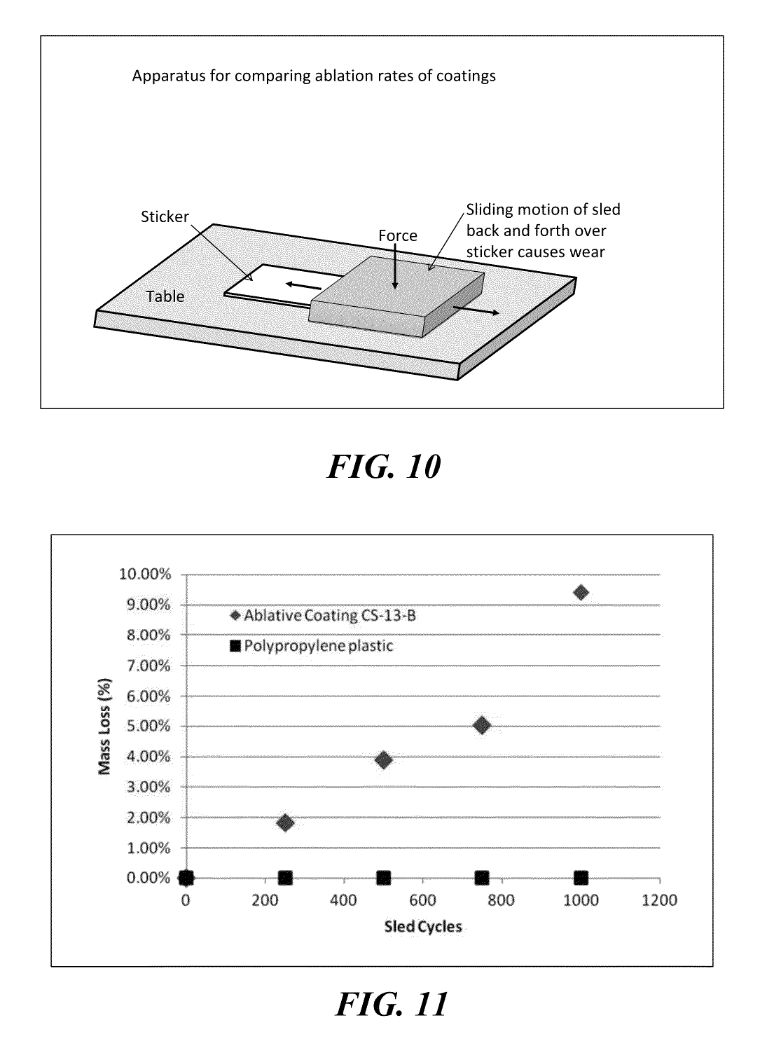

FIG. 10 schematically illustrates a wear rate testing apparatus used to evaluate various ablative layers to determine if the wear properties exhibited by various ablative layer formulations were sufficient to achieve the self-cleansing coating disclosed herein, suitable for reducing microbial cross communication between users. For the empirical tests, a 25 gm sled was fitted with 1000 grit sand paper on bottom of the sled. The sled was pushed and pulled over the test coupon (an ablative sticker or a piece of non-ablative plastic). One ablative cycle was defined as a push and a pull, with the sled moving twice across the sticker. The CS-13-B ablative coating formulation included 78% PDMS, 20% alumina silicate powder, and 2% PHMB.

FIG. 11 graphically shows the results using the apparatus of FIG. 10 to test an ablative material and a non-ablative material. The polypropylene did not lose a measurable amount of mass. Under identical conditions, the CS-13-B material lost approximately 9.5% of its mass. In terms of the ablative coating disclosed herein, unmodified polypropylene was not an acceptable ablative coating material (i.e., the polypropylene did not wear fast enough, and would not exhibit the desired wear pattern when handled by people touching a polypropylene coated surface), whereas the CS-13-B material exhibited more desirable characteristics for the ablative layer disclosed herein.

### INDUSTRIAL APPLICABILITY

The present invention has industrial applicability in the production of anti microbial coatings and in the treatment of surfaces to prevent the spread of microbes.

Although the concepts disclosed herein have been described in connection with the example forms of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

We claim:

1. A method for treating a surface touched by people to reduce an amount of microbes transferred to people touching the surface, the method comprising the step of depositing a conformal coating onto the surface, the coating comprising an ablative layer, the ablative layer being formed of a material sufficiently soft or frangible such that the ablation layer is worn away in response to repeated human contact, said coating comprising a material that is hydrophobic when the conformal coating has cured.

2. The method of claim 1, wherein the step of depositing the conformal coating comprises the step of spraying a liquid conformal coating solution onto the surface, the conformal coating curing as a solvent in the solution evaporates.

3. The method of claim 1, wherein the step of depositing the conformal coating comprises the step wiping the surface with a wipe saturated with a liquid conformal coating solution onto the surface, the conformal coating curing as a solvent in the solution evaporates.

4. The method of claim 3, wherein the liquid conformal coating comprises poly ethylene glycol, ethanol and an antimicrobial agent onto the surface.

5. The method of claim 3, wherein the liquid conformal coating comprises poly ethylene glycol, ethanol, water, polyhexamethylene biguanide, and titanium dioxide.

6. The method of claim 1, further comprising including a tag in the coating that can be detected using an optical sensor, thereby enabling the presence of the conformal coating on the surface to be detected, wherein the tag cannot be detected by the human eye.

7. The method of claim 6, wherein the tag can be detected using a long-wavelength infrared sensor.

8. The method of claim 7, further comprising the steps of
(a) positioning the sensor at a location from which the presence of the conformal coating can be detected; and
(b) monitoring the sensor to determine when the conformal coating needs to be refreshed.

9. The method of claim 8, wherein the step of monitoring the sensor comprises the step of sending sensor data to a mobile computing device to alert a user of the mobile computing device that the conformal coating needs to be refreshed.

10. The method of claim 9, wherein the mobile computing device is a smart phone.

11. The method of claim 9, further comprising the step of depositing an additional quantity conformal coating on the surface in response to the sensor indicating that the ablative conformal coating needs to be refreshed.

12. The method of claim 8, further comprising the step of using the sensor as a fire detector, such that the sensor provides data serving multiple functions.

13. A method for treating a surface touched by people to reduce an amount of microbes transferred to people touching the surface, the method comprising the step of depositing a conformal coating onto the surface, the coating comprising an antimicrobial material and a tag that can be detected using an optical sensor but not the human eye, thereby enabling the presence of the conformal coating on the surface to be detected.

14. A surface treatment comprising a container and a fluid, said fluid being readily dispensed from said container, and said fluid comprising:
(a) a material that is hydrophobic when not in solution, and easily worn by repeated contact with human skin;
(b) a solvent; and
(c) an antimicrobial;
whereby said fluid forms a conformal coating onto a surface on which the fluid is deposited after the solvent has evaporated, and whereby the conformal coating so formed is sufficiently soft or frangible such that the conformal coating is worn away in response to repeated human contact.

15. The fluid of claim 14 being further comprising of a material capable of thickening the fluid into viscous liquid or gel.

16. The fluid of claim 14 wherein the solvent is water.

17. The fluid of claim 14 wherein the solvent is a mixture of alcohol and water.

18. The fluid of claim 14 wherein the hydrophobic material is one or more of the following:
(a) a low molecular weight PEG with an average molecular weight less than 5,000 atomic mass units;
(b) a medium molecular weight PEG with an average molecular weight between 5,000 and 30,000 atomic mass units; and
(c) a high molecular weight PEG with an average molecular weight greater than 30,000 atomic mass units.

19. The fluid of claim 14 wherein the antimicrobial is one or more of the following:
(a) PHMB;
(b) Thymol;
(c) Polylysine;
(d) a quaternary ammonium compound;
(e) sodium hypochlorite;
(f) a peroxide compound;
(g) a compound known to create singlet oxygen when stimulated by photons.

20. The fluid of claim 14, further comprising a non-soluble powder comprising one of the following ceramics:
(a) titanium dioxide;
(b) aluminosilicate;
(c) alum; and
(d) cosmetic grade kaolin.

21. A hand sanitizer comprising a container and a fluid, said fluid being readily dispensed from said container, and said fluid comprising:
(a) a material that is hydrophobic when not in solution, and easily worn by repeated contact with human skin;
(b) a solvent; and
(c) an antimicrobial;
whereby said fluid forms a conformal coating onto human skin upon which the fluid is deposited after the solvent has evaporated, and whereby the conformal coating so formed is sufficiently soft or frangible such that the conformal coating is worn away in response to repeated human skin contact with other objects.

22. A touch screen sanitizer comprising a container and a fluid, said fluid being readily dispensed from said container, and said fluid comprising:
(a) a material that is hydrophobic when not in solution, and easily worn by repeated contact with human skin;
(b) a solvent; and
(c) an antimicrobial;
whereby said fluid forms a conformal coating onto a touch screen upon which the fluid is deposited after the solvent has evaporated, and whereby the conformal coating so formed is sufficiently soft or frangible such that the conformal coating is worn away in response to repeated human skin contact with the touch screen.
